(19) United States
(12) Patent Application Publication
(10) Pub. No.: US 2012/0129511 A1
(43) Pub. Date: May 24, 2012

(54) MOBILE PHONE AND OPERATING METHOD THEREOF

(75) Inventor: Chih-Kai HSU, Taipei (TW)

(73) Assignee: INVENTEC CORPORATION, Taipei (TW)

(21) Appl. No.: 13/086,652

(22) Filed: Apr. 14, 2011

(30) Foreign Application Priority Data
Nov. 19, 2010 (CN) 201010558003.9

(51) Int. Cl. H04M 3/00; H04B 1/38; H04M 1/00

(52) U.S. Cl. 455/418; 455/550.1; 455/566

(57) ABSTRACT

A mobile phone operating method including the following steps is provided. A first key of a mobile phone is pressed. The mobile phone is shaken as the first key is pressed, such that a first gesture is sensed by a g-sensor of the mobile phone. Whether a combination of the first key and the first gesture corresponds to a preset function is determined by a processing unit of the mobile phone. The preset function is performed by the mobile phone if the determination is affirmative.

This application claims the benefit of People's Republic of China application Serial No. 201010558003.9, filed Nov. 19, 2010, the subject matter of which is incorporated herein by reference.

### BACKGROUND OF THE INVENTION

1. Field of the Invention

The invention relates in general to a mobile phone and an operating method thereof, and more particularly to a mobile phone with high convenience and an operating method thereof.

2. Description of the Related Art

Normally, the call records or text messages stored in the mobile phone are not hidden or encrypted. If the mobile phone is lost or borrowed by somebody to surf, the personal information of the call records or text message might be viewed or divulged. Currently, there are various sorts of software available in the market for encrypting or hiding the text messages. However, these sorts of software merely encrypt or hide the text messages but not the software, and are like a clumsy denial. In addition, the present encryption software and the hide software are user-unfriendly, require complicated settings, and are against the principles of the mobile phone which should be convenient and instantaneous.

### SUMMARY OF THE INVENTION

The invention is directed to a mobile phone and an operating method thereof which enable the mobile phone to conveniently perform corresponding preset function with the combination of key and movement gesture.

According to a first aspect of the present invention, a mobile phone operating method including the following steps is provided. A first key of a mobile phone is pressed. The mobile phone is shaken as the first key is pressed, such that a first gesture is sensed by a g-sensor of the mobile phone. Whether a combination of the first key and the first gesture corresponds to a preset function is determined by a processing unit of the mobile phone. The preset function is performed by the mobile phone if the determination is affirmative.

According to a second aspect of the present invention, a mobile phone including a processing unit, multiple keys and a g-sensor is provided. The multiple keys are electrically connected to the processing unit. The g-sensor is electrically connected to the processing unit. The g-sensor senses the mobile phone and obtains a first gesture as a first key of the keys is pressed. The processing unit determines whether a combination of the first key and the first gesture corresponds to a preset function. The mobile phone performs the preset function if the determination is affirmative.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a mobile phone according to a preferred embodiment of the invention; and

FIG. 2 shows a flowchart of a mobile phone operating method according to a preferred embodiment of the invention.

### DETAILED DESCRIPTION OF THE INVENTION

The invention provides a mobile phone and operating method thereof, which enable the mobile phone to conveniently perform corresponding preset functions with the combination of key and movement gesture.

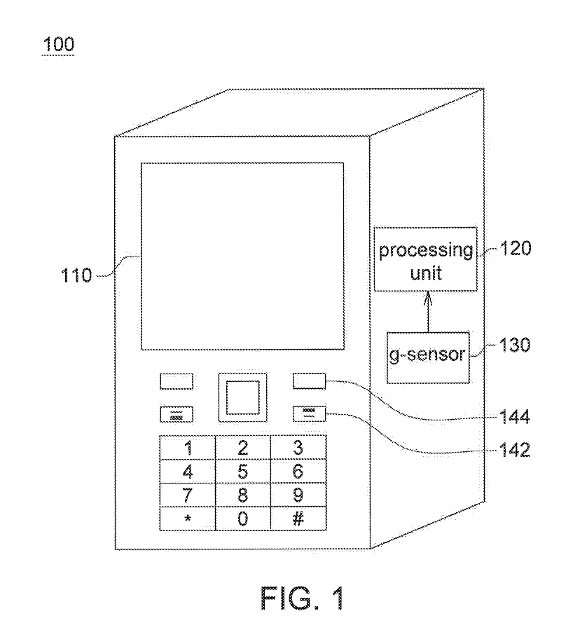

Referring to FIG. 1, a mobile phone according to a preferred embodiment of the invention is shown. The mobile phone 100 includes a screen 110, a processing unit 120, multiple keys and a g-sensor 130. The multiple keys are electrically connected to the processing unit 120. The g-sensor 130 is electrically connected to the processing unit 130. As a first key of the multiple keys is pressed, the g-sensor 130 senses the mobile phone 100 and obtains a first gesture. The processing unit 120 determines whether a combination of the first key and the first gesture corresponds to a preset function. The mobile phone 100 performs the preset function if the determination is affirmative.

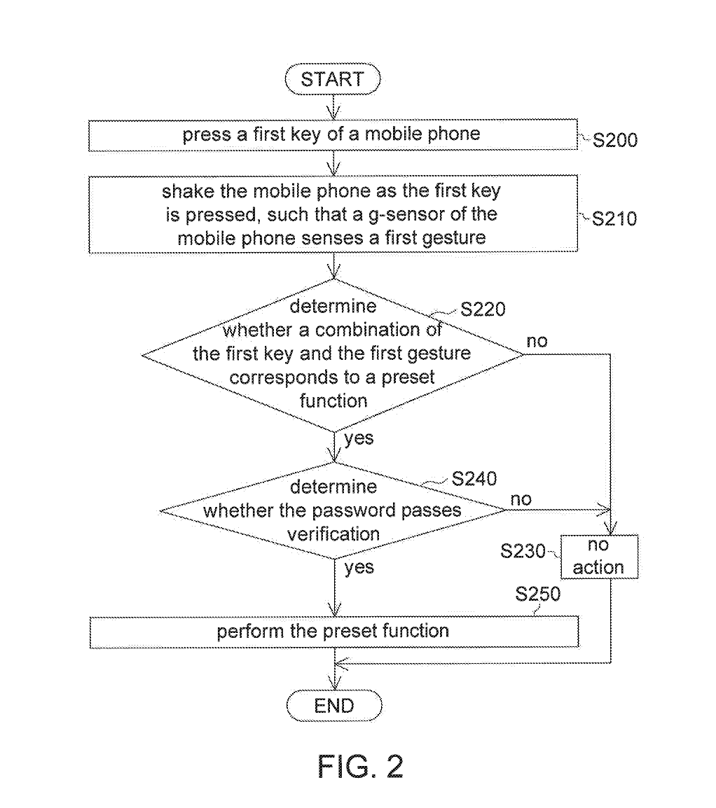

Referring to FIG. 2, a flowchart of a mobile phone operating method according to a preferred embodiment of the invention is shown. In step S200, a first key of the mobile phone 100 is pressed. In step S210, the mobile phone 100 is shaken as the first key is pressed, such that a g-sensor 130 of the mobile phone 100 senses a first gesture of the mobile phone 100. To avoid the occurrence of erroneous action, the g-sensor 130 is activated to sense the first gesture only after the first key has been pressed for a specific duration (such as 3 seconds).

In step S220, whether a combination of the first key and the first gesture corresponds to a preset function is determined by the processing unit 120 of the mobile phone. If the combination does not correspond to any preset function, then the method proceeds to step S230, no action is taken by the mobile phone 100 and the screen 110 is maintained at a previous frame. If the combination of the first key and the first gesture corresponds to a preset function, then the method proceeds to step S240, a password requesting instruction is transmitted by the processing unit 120 to be displayed on the screen 110, and a password is inputted by the user and checked by the processing unit 120 which determines whether the password passes verification or not. Step S240 is substantially designed to exclude the occurrence of erroneous action, and is an optional step that can be omitted. If the inputted password does not pass verification, then the method proceeds to step S230. If the inputted password passes verification, then the method proceeds to step S250, the preset function is performed by the mobile phone 100. Examples of the preset function include displaying or hiding a specific data, but are not limited to the above exemplifications.

Assume that the contact data of the mobile phone 100 are divided into two groups, namely, the “workmates” group and the “family members” group. The user can preset the combination of the key and the movement gesture corresponding to the “workmates” group as “press the end key 142 and shake the mobile phone 100 leftward and rightward in order for one time” and request the verification of password be performed. The user can also set the combination of the key and the movement gesture corresponding to the “family members” group as “press the return key 144 and shake the mobile phone 100 rightward and leftward in order for one time”. The user can further set the combination of the key and the movement gesture corresponding to “display all contact data” as “press the return key 144 and shake the mobile phone 100 upward and downward in order for one time”.

After the mobile phone 100 enters the menu of contact list, all contact data (excluding the contact data requiring password) will be displayed on the screen 110 by the processing unit 120. Next, the end key 142 is pressed and the mobile phone 100 is shaken leftward and rightward in order for one time as disclosed in step S200 and S210. As disclosed in step S220 and S240, the user will be requested to input a password by the processing unit 120 after it is determined that the above combination of key and movement gesture corresponds to a preset function. If the inputted password passes verification, then as disclosed in step S250, the contact data of the “workmates” group will be displayed on the screen 110 by the mobile phone 100.

Then, as disclosed in step S200 and S210, the return key 144 is pressed and the mobile phone 100 is shaken rightward and leftward in order for one time. As disclosed in step S220 and S240, since no password is requested, after it is determined that the above combination of key and movement gesture corresponds to a preset function, the method proceeds to step S250, the contact data of the “family members” group will be displayed on the screen 110 by the mobile phone 100. Afterwards, as disclosed in step S200 and S210, the return key 144 is pressed and the mobile phone 100 is shaken downward and upward in order for one time. As disclosed in step S220, after it is determined that the above combination of key and movement gesture does not correspond to a preset function, the method proceeds to step S230, no action is taken by the mobile phone 100 and the contact data of the “family member” group remain on the screen 110.

Assume that the mails of the mobile phone 100 are divided into two groups, namely, the “business secret” group and the “general business” group. The user can preset the combination of the key and the movement gesture corresponding to the “business secret” group as “press the end key 142 and shake the mobile phone 100 leftward and rightward in order for one time” and request the verification of password be performed. The user can also set the combination of the key and the movement gesture corresponding to the “general business” as “press the return key 144 and shake the mobile phone 100 rightward and leftward in order for one time”. The user can further set the combination of the key and the movement gesture corresponding to “display all mail” as “press the return key 144 and shake the mobile phone 100 upward and downward in order for one time”.

After the mobile phone 100 enters the menu of mail list, all mails (excluding the mails requiring password) will be displayed on the screen 110 by the processing unit 120. Next, as disclosed in step S200 and S210, the end key 142 is pressed and the mobile phone 100 is shaken leftward and rightward in order for one time. As disclosed in step S220 and S240, the user will be requested to input a password by the processing unit 120 after it is determined that the above combination of key and movement gesture corresponds to a preset function. If the inputted password passes verification, then as disclosed in step S250, then the mails of the “business secret” will be displayed on the screen 110 by the mobile phone 100.

Then, as disclosed in step S200 and S210, the return key 144 is pressed and the mobile phone 100 is shaken rightward and leftward in order for one time. As disclosed in step S220 and S240, since no password is requested, after it is determined that the above combination of key and movement gesture corresponds to a preset function, the method proceeds to step S250, the mails of the “general business” group will be displayed on the screen 110 by the mobile phone 100. Afterwards, as disclosed in step S200 and S210, the return key 144 is pressed and the mobile phone 100 is shaken downward and upward in order for one time. As disclosed in step S220, after it is determined that the above combination of key and movement gesture does not correspond to a preset function, the method proceeds to step S230, no action is taken by the mobile phone 100 and the mails of the “general business” group remain on the screen 110.

Assume the program sets of the mobile phone 100 are divided into two groups, namely, the “tool” group and the “entertainment” group. The user can preset the combination of the key and the movement gesture corresponding to the “tool” group as “press the end key 142 and shake the mobile phone 100 leftward and rightward in order for one time” and request the verification of password be performed. The user can also set the combination of the key and the movement gesture corresponding to the “entertainment” group as “press the return key 144 and shake the mobile phone 100 rightward and leftward in order for one time”. The user can further set the combination of the key and the movement gesture corresponding to “display all programs” as “press the return key 144 and shake the mobile phone 100 upward and downward in order for one time”.

After the mobile phone 100 enters the menu of programs list, all programs (excluding the programs requiring password) will be displayed on the screen 110 by the processing unit 120. Next, as disclosed in step S200 and 3210, the end key 142 is pressed and the mobile phone 100 is shaken leftward and rightward in order for one time. As disclosed in step S220 and S240, the user will be requested to input a password by the processing unit 120 after it is determined that the above combination of key and movement gesture corresponds to a preset function. If the inputted password passes verification, then as disclosed in step S250, then the programs of the “tool” group will be displayed on the screen 110 by the mobile phone 100.

Then, as disclosed in step S200 and S210, the return key 144 is pressed and the mobile phone 100 is shaken rightward and leftward in order for one time. As disclosed in step S220 and S240, since no password is requested, after it is determined that the above combination of key and movement gesture corresponds to a preset function, the method proceeds to step S250, the programs of the “entertainment” group will be displayed on the screen 110 by the mobile phone 100. Afterwards, as disclosed in step S200 and S210, the return key 144 is pressed and the mobile phone 100 is shaken downward and upward in order for one time. As disclosed in step S220, after it is determined that the above combination of key and movement gesture does not correspond to a preset function, the method proceeds to step S230, no action is taken by the mobile phone 100 and the programs of the “entertainment” group remain on the screen 110.

Assume a private text message is stored in the mobile phone 100. The user can preset the combination of the key and the movement gesture corresponding to “hide private text message” as “press the end key 142 and shake the mobile phone 100 leftward and rightward in order for one time”. The user can also set the combination of the key and the movement gesture corresponding to “display private text message” group as “press the end key 142 and shake the mobile phone 100 rightward and leftward in order for one time” and request the verification of password be performed. The user can further set the combination of the key and the movement gesture corresponding to “display all text message” as “press the return key 144 and shake the mobile phone 100 upward and downward in order for one time”.

After the mobile phone 100 enters the menu of text message, all text messages (excluding the text messages requiring password) will be displayed on the screen 110 by the processing unit 120. Next, as disclosed in step S200 and S210, the end key 142 is pressed and the mobile phone 100 is shaken leftward and rightward in order for one time. As disclosed in step S220 and S240, since no password is requested, after it is determined that the above combination of key and movement gesture corresponds to a preset function, the method proceeds to step S250, the “hide private text message” will be performed by the mobile phone 100 to hide the designated text message.

Then, as disclosed in step S200 and S210, the return key 144 is pressed and the mobile phone 100 is shaken upward and downward in order for one time. As disclosed in step S220 and S240, since there is a hidden text message, the user will be requested to input a password by the processing unit 120 after it is determined that the above combination of key and movement gesture corresponds to a preset function. If the correct password is not inputted, then only the non-hidden text messages will be displayed by the mobile phone 100.

Then, as disclosed in step S200 and S210, the end key 142 is pressed and the mobile phone 100 is shaken rightward and leftward in order for one time. As disclosed in step S220 and S240, the user will be requested to input a password by the processing unit 120 after it is determined that the above combination of key and movement gesture corresponds to a preset function. If the password passes verification, then the method proceeds to step S250, “display private text message” will be performed by the mobile phone 100 to display the hidden text message on the screen 110.

The mobile phone and operating method thereof disclosed in the above embodiments of the invention have many advantages exemplified below:

According to the mobile phone and operating method thereof disclosed in the invention, multiple combinations of keys and movement gestures are set to correspond to different preset functions, such that the mobile phone can conveniently perform corresponding preset functions under specific circumstances. Besides, the mobile phone operating method of the invention does not require extra software, and is free of the inconvenience that the hide software itself cannot be hidden. Furthermore, the mobile phone and operating method thereof of the invention are easy to operate, have simple setting and provide high convenience to the user.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A mobile phone operating method, comprising:
pressing a first key of a mobile phone;
shaking the mobile phone as the first key is pressed, such that a first gesture is sensed by a g-sensor of the mobile phone;
determining whether a combination of the first key and the first gesture corresponds to a preset function by a processing unit of the mobile phone; and
performing the preset function by the mobile phone if the determination is affirmative.

2. The mobile phone operating method according to claim 1, wherein after the first key is pressed for up to a specific duration, the g-sensor is activated to sense the first gesture.

3. The mobile phone operating method according to claim 1, wherein the mobile phone performs the preset function to display a specific data.

4. The mobile phone operating method according to claim 3, wherein the specific data is at least one contact data.

5. The mobile phone operating method according to claim 3, wherein the specific data is at least one mail set.

6. The mobile phone operating method according to claim 3, wherein the specific data is at least one program set.

7. The mobile phone operating method according to claim 3, wherein the specific data is at least one text message.

8. The mobile phone operating method according to claim 3, wherein the specific data is at least one incoming call display.

9. The mobile phone operating method according to claim 1, wherein the mobile phone performs the preset function to hide a specific data.

10. The mobile phone operating method according to claim 9, wherein the specific data is at least one contact data.

11. The mobile phone operating method according to claim 9, wherein the specific data is at least one mail set.

12. The mobile phone operating method according to claim 9, wherein the specific data is at least one program set.

13. The mobile phone operating method according to claim 9, wherein the specific data is at least one text message.

14. The mobile phone operating method according to claim 9, wherein the specific data is at least one incoming call display.

15. The mobile phone operating method according to claim 1, further comprising:
transmitting a password requesting instruction by the processing unit as the processing unit determines that the combination of the first key and the first gesture corresponds to the preset function;
inputting a password to the mobile phone; and
performing the preset function by the mobile phone if the password passes verification.

16. A mobile phone, comprising:
a processing unit;
a plurality of keys electrically connected to the processing unit; and
a g-sensor electrically connected to the processing unit;
wherein, as a first key of the keys is pressed, the g-sensor senses the mobile phone and obtains a first gesture, the processing unit determines whether a combination of the first key and the first gesture corresponds to a preset function, and if the determination is affirmative, then the mobile phone performs the preset function.

17. The mobile phone according to claim 16, wherein after the first key is pressed for up to a specific duration, the g-sensor is activated to sense the first gesture.

18. The mobile phone according to claim 16, wherein the mobile phone performs the preset function to display a specific data on a screen of the mobile phone.

19. The mobile phone according to claim 16, wherein the mobile phone performs the preset function to hide a specific data on a screen of the mobile phone.

20. The mobile phone according to claim 16, wherein as the processing unit determines that the combination of the first key and the first gesture corresponds to the preset function, the processing unit transmits a password requesting instruction, and the mobile phone performs the preset function if an inputted password passes verification.
